(19) United States
(12) Patent Application Publication
(10) Pub. No.: US 2026/0267288 A1
(43) Pub. Date: Sep. 10, 2026

(54) METHOD FOR MANUFACTURING A SERIES OF TIMEPIECE MOVEMENTS

(71) Applicant: BREITLING SA, Grenchen (CH)

(72) Inventors: Kilian EISENEGGER, Kallnach (CH); Michael OPPLIGER, Cortaillod (CH)

(21) Appl. No.: 19/163,799

(22) PCT Filed: Mar. 5, 2024
(86) PCT No.: PCT/EP2024/055654

§ 371 Date: Sep. 9, 2025

(30) Foreign Application Priority Data
Mar. 10, 2023 (EP) 23161229.2

(51) Int. Cl. G04B 17/06; G04D 7/04; G04D 7/10

(52) U.S. Cl. CPC G04B 17/066; G04B 17/063; G04D 7/04; G04D 7/10

(57) ABSTRACT

A method for manufacturing a series of timepiece movements (1), comprising steps of:-manufacturing a plurality of balance springs (13);—measuring the stiffness of each of said balance springs (13) and sorting them according to a plurality of classes A1 of stiffness;—manufacturing a plurality of balances (11) according to a moment-of-inertia distribution determined as a function of said classes of stiffness of said balance springs (13);—measuring the moment of inertia of each of said balances (11) and sorting them by moment of inertia into a plurality of classes;—defining a first group of classes of balance spring (13) and a second group classes of balance spring (13), in which the classes of each individual group are sequential, the mean stiffness of the balance springs (13) of the second group of classes of balance spring (13) being greater than the mean stiffness of the balance springs (13) of the first group of 2024/188704 classes of balance spring (13):—pairing each class of balance spring (13) with a corresponding class of balances (11);—assembling a plurality of spring-balance (11, 13) oscillators (9), each comprising a balance spring (13) and a balance (11) which have been paired by class;-assembling a series of timepiece movements (1) each comprising one of said spring-balance (11, 13) oscillators (9) arranged to be maintained by an escapement (7, 15) comprising an escape wheel (7) driven by a going train (5), and in which, for the oscillators (9) comprising balance spring (13) from the second group classes, said corresponding movements (1) are arranged such that the torque available to said escape wheel (7) is less than the torque available to the escape wheel (7) for movements incorporating oscillators (9) comprising a balance spring (13) of the first group of classes.

### TECHNICAL FIELD

The present invention relates to the field of watchmaking. It relates, more particularly, to a method for manufacturing a series of timepiece movements.

### State of the Art

In order to obtain a good oscillation frequency for a balance-hairspring oscillator, utmost care is necessary in terms of the moment of inertia of the balance and the return torque provided by the hairspring associated therewith. When manufacturing large series of timepieces, it is not economically viable to call upon an experienced watchmaker to manufacture or to modify these two components very precisely for each individual movement, and the industry utilizes apparatuses applying the “Omega-Metric” method in order to automate the determination of the torques of the hairsprings and the moment of inertia of the balances.

The torque distribution of the hairsprings and the distribution of the moment of inertia of the balances that are manufactured in series each follow a substantially Gaussian curve, and each component is sorted according to classes, depending on the torque and the moment of inertia, respectively. The number of classes is typically 20, the difference between the adjacent classes corresponding to a rate variation of typically 150 seconds per day.

The hairsprings of a stiffer class are matched with balances of a class with greater moment of inertia, and vice versa, each class of balances corresponding to a class of hairsprings in such a way as to minimize the differences in oscillation frequency for the majority of production of the components. This method is described in the work Théorie d'Horlogerie [The Theory of Horology], Reymondin et al, page 146, and is called “pairing”. Moreover, document EP3845770 discloses the classification of hairsprings.

However, it is possible that a certain number of hairsprings do not fall into the classes used, and are either rejected or subjected to reworking, such as, for example, through addition of material in order to increase the stiffness or removal of material in order to reduce it, the latter possibility typically being selected for hairsprings made of non-metallic material (silicon, silicon oxide, etc.) but also being applicable to traditional hairsprings made of metal.

If the number of classes is increased in order to cover a larger part of the production series of the hairsprings, it is indeed possible to carry out pairing in terms of the oscillation frequency, by providing suitably classified balances, but the amplitude variation between an oscillator comprising a hairspring of the stiffest class and an oscillator comprising a hairspring of the least stiff class becomes unmanageable. Typically, for a conventional classification with 20 classes, the amplitude variation will be of the order of 20° to 25°, whereas, if 20 additional classes each with 150 s/d are added, the amplitude variation increases up to 50° over the entire series, which is unacceptable for a quality timepiece and impairs the chronometric properties thereof. Moreover, if the oscillation amplitude becomes too great, the risk of tripping is increased and is to be avoided.

The aim of the invention is therefore to propose a method for manufacturing a series of timepiece movements in which the shortcomings mentioned above are at least partially overcome, and which makes it possible to use a wider range of hairsprings without the need for reworking.

### Disclosure of the Invention

More specifically, the invention relates to a method for manufacturing a series of timepiece movements, as defined by claim 1. This method comprises the steps of:
manufacturing a plurality of hairsprings;
measuring the stiffness of each of said hairsprings and sorting them according to a plurality of stiffness classes (also typically by classes of 150 s/day);
manufacturing a plurality of balances having a determined distribution of moments of inertia depending on said stiffness classes of said hairsprings, that is to say balances of which at least a portion are capable of being correctly matched with the hairsprings manufactured and sorted into the selected classes of hairsprings;
measuring the moment of inertia of each of said balances (11) and sorting them according to a plurality of classes by moment of inertia;
defining a first group of classes of hairsprings and a second group of classes of hairsprings, of which the classes of each individual group are sequential, the average stiffness (and therefore return torque) of the hairsprings of the second group of classes of hairsprings being greater than the average stiffness of the hairsprings of the first group of classes of hairsprings;
pairing each class of hairsprings with a corresponding class of balances;
assembling a plurality of balance-hairspring oscillators each comprising a hairspring and a balance which are thus paired by classes;
assembling a series of timepiece movements each comprising one of said balance-hairspring oscillators arranged to be sustained in oscillation by an escapement of any type comprising an escape wheel arranged to be driven by a going train, in which, for the oscillators comprising a hairspring of the second group of classes, said corresponding movements are arranged in such a way that the torque available at the escape mobile is lower than the torque available at said escape mobile for movements incorporating oscillators comprising a hairspring of the first group of classes.

By these means, a greater variation in balance-spring torque can be used without the need for reworking, by compensating for the tendency for hairsprings in the stiffest classes and also to increase the oscillation amplitude of the oscillator. This is effected by reducing the torque available at the escape mobile during the operation of the movement, and this reduces the intensity of the impulses provided by the escapement to the balance-hairspring oscillator, and therefore brings the oscillation amplitude back into an acceptable range. Hairspring manufacturing losses and/or the reworking of part of the production can be reduced or even eliminated.

Of course, the same principle can be applied to more than two groups of classes.

In one variant, said torque available at the escape mobile is determined by adjusting the output torque of a constant-force mechanism comprised by each movement.

In another variant, said torque available at the escape mobile is determined at the barrel, such as, for example, by providing mainsprings having at least two different powers, a more powerful mainspring being selected for the movements containing hairsprings of the first group of classes and a less powerful mainspring being selected for the movements containing hairsprings of the second group of classes.

In yet another variant, said torque available at the escape mobile is determined in terms of the form of the toothing of a predetermined mobile of the going train. For example, two types of said predetermined mobile having two toothing forms arranged so as to have two different gear efficiencies can be provided, one of said predetermined mobiles with greater gear efficiency being selected for movements containing hairsprings of the first group of classes and one of said predetermined mobiles with lower efficiency being selected for the movements containing hairsprings of the second group of classes.

Advantageously, said two toothing forms are cut by means of the same form of cutter, said cutter being adjusted to cut a toothing at a greater radius in order to obtain mobiles having said lower efficiency, and to cut a toothing at a smaller radius in order to obtain mobiles having said greater efficiency.

In so doing, the two types of mobiles can be manufactured with the same tools, the only difference being the position of the cutter during the cutting of the toothing concerned.

Typically, said predetermined mobile of the going train is the third mobile, said two different toothings being provided for the third wheel, which typically meshes with the seconds pinion. However, the constructor is free to choose the mobile and the toothing concerned.

With regard to the spread of the groups of classes, in one variant, all of the set of classes of the first group of classes are different from all of the set of classes of the second group of classes: in other words, there are no common classes between the two groups, each class of the first group being different from each class of the second group. However, it is also possible for a portion of the classes of the first group to overlap with a portion of the classes of the second group, such that some of the classes of the first group of classes correspond to some of the classes of the second group of classes.

The invention also relates to a series of timepiece movements which is manufactured according to the method described above, and to a timepiece comprising a movement belonging to said series of movements.

### BRIEF DESCRIPTION OF THE DRAWINGS

Other details of the invention will become more clearly apparent upon reading the following description, in reference to the attached drawings in which:

FIG. 1 is a schematic view of a conventional timepiece movement;

FIG. 2 is a schematic view of a timepiece movement incorporating a constant-force mechanism;

FIG. 3 is a view of the gearing between the third wheel and the seconds pinion, arranged to provide a greater gear efficiency;

FIG. 4 is a view of the gearing between the third wheel and the seconds pinion, arranged to provide a lower gear efficiency than that in FIG. 4.

### EMBODIMENTS OF THE INVENTION

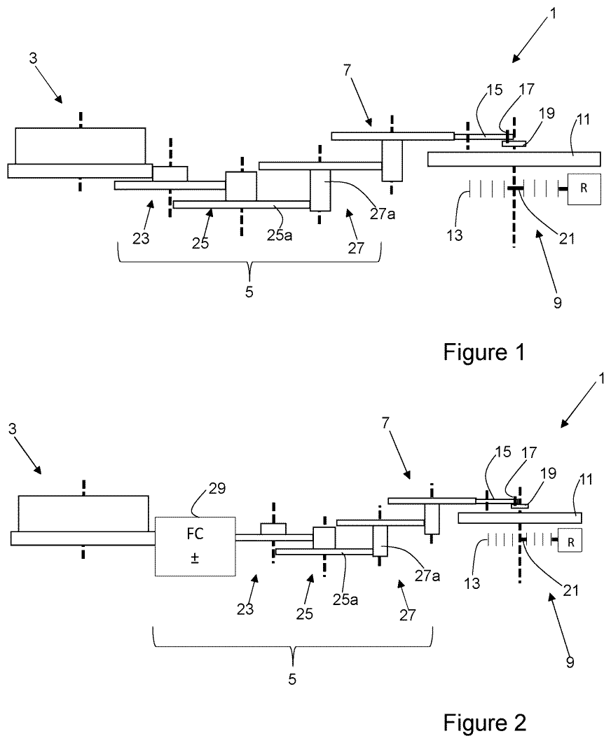

FIG. 1 schematically illustrates, seen from the side, a conventional timepiece movement 1, the toothings being illustrated by the primitive circles thereof and the pivot axes of the various members being illustrated by dashed lines.

The movement comprises a barrel 3 housing a conventional mainspring (not illustrated), a going train 5 kinematically connecting the barrel 3 to an escape mobile 7, which sustains an oscillator 9 of the balance 11 hairspring 13 type by means of an anchor 15 which cooperates with an impulse pin 17 of a roller 19 which rotates as one with said balance 11. Of course, other forms of escapement (for example a detent escapement, Omega-Daniels escapement, etc.) can also be used, and the present invention is not limited to a particular type of escapement. Moreover, the form of the balance can also be freely chosen.

Conventionally, the inner end of the hairspring 13 is fastened to a collet which rotates as one with said balance 11, and the outer end is fastened to an index assembly R, the elements of which have not been illustrated but are well known to those skilled in the art and serve to fasten the outer end of the hairspring 13 and to modify its active length in order to regulate the rate of the oscillator 9, and therefore of the movement, by means of a conventional index assembly. The present invention is not limited to a particular form of the hairspring 13, helical or spherical hairsprings 13, Breguet overcoils and others also being concerned, and it is also not limited to specific materials. For example, the hairspring 13 may be manufactured from conventional metal, metallic glass (amorphous metal), silicon, silicon oxide, synthetic diamond, aluminum oxide, ceramic, ceramic glass or any other material known to those skilled in the art, manufactured by any method suitable for the material concerned (rolling and winding, sintering in a mold, additive manufacturing, LIGA, cutting from a plate by laser or etching, etc.).

The going train 5 may take any known form, and in this case takes a conventional construction, comprising a second mobile 23 (or alternatively center mobile, where appropriate) meshing with the barrel 3 by way of the second pinion and with the pinion of a third mobile 25 by way of the second wheel, the third wheel 25a of the third mobile 25 meshing in turn with the seconds pinion 27a of a seconds mobile 27, the seconds wheel of which meshes with the escape pinion of the escape mobile 7. Of course, the rotation speeds and the number of mobiles can be determined at the option of the constructor.

In order to make the natural frequency of the oscillator 9 sufficiently close to the desired frequency, such that only an adjustment of the index assembly is necessary to regulate the movement, a production series of hairsprings 13 and balances 11 is produced and sorted by classes of stiffness and moment of inertia, respectively, for example according to the Omega-Metric method, the balances 11 being manufactured by targeting a distribution of moments of inertia that is suitable for the distribution of stiffnesses of the hairsprings 13. Typically, this method sorts the hairsprings 13 and the balances 11 by twenty classes which imply a difference in rate of 150 seconds per day (s/d) from one class to the adjacent class, pairing between the classes being effected so as to put hairsprings 13 which tend to cause a rate gain (that is to say stiffer hairsprings 13) together with balances 11 which tend to cause a rate loss (that is to say balances 11 with greater moment of inertia) and vice versa, in order to obtain oscillators 9 capable of being correctly regulated by means of the index assembly. For accredited movements, the difference in oscillation amplitude of an oscillator 9 comprising a hairspring 13 of the first class with respect to an oscillator 9 comprising a hairspring 13 of the twentieth class is of the order of 20° to 25° in total, that is to say of +12.5° around the average amplitude of the series of oscillators 9. Of course, a different amplitude deviation is possible, and the figures are given only by way of example.

In the case of a large production series, it could be that a significant quantity of hairsprings 13 fall outside the classification according to twenty classes each with 150 s/d (or the classification by different bands, where appropriate). In order to minimize production losses, as many of these hairsprings 13 as possible are typically reworked by various means so as to make them fall into the classes used and minimize production losses. For hairsprings 13 which are not stiff enough and the return torque of which is inadequate, addition of material by inkjet printing or by vacuum deposition, ion implantation in order to increase the shear modulus or the like, may be effected. In the case of hairsprings 13 which are too stiff, removal of material by laser is the typical solution.

In order to avoid, or minimize, reworking, it would in principle be possible simply to increase the number of classes of hairsprings 13, and to manufacture corresponding balances 11 in order to be able to match them and thus obtain a suitable natural oscillation frequency. However, this way of proceeding increases the variation in amplitude, and for forty classes each with 150 s/d, this variation may increase up to 50° in total (that is to say up to ±25° around the average amplitude of the series of oscillators). This is not acceptable in terms of the chronometric properties, and may even increase the risk of tripping if the oscillation amplitude becomes too high.

The solution of the present invention is as follows. The number of classes of hairsprings 13 is increased, and the number of these classes is divided into two groups, a first of which has a lower average stiffness, and the second of which has a greater average stiffness.

The set of classes of the two groups may be consecutive, that is to say representing just one distribution (typically Gaussian) of hairsprings 13, or may represent two distributions (again typically Gaussian) by means of a manufacturing operation targeting two such distributions. In this latter case, some lower classes of the second group will correspond to some upper classes of the first group, that is to say that there will be an overlap between the classes of the two groups.

Balances 11 are manufactured and classified by moment of inertia in the same way, such that the number of distinct classes of balances 11 corresponds to the number of distinct classes of hairsprings 13, in order to be able to effect pairing for each hairspring 13 thus classified. For example, if hairsprings 13 are classified according to two distinct groups of 20 classes each, 40 classes of balances will be manufactured and used. However, if, for example, the 5 upper classes of the first group correspond to the 5 lower classes of the second group, the number of distinct classes of balances will be 35, due to the overlap of 5 classes between the two groups.

Since the hairsprings of the second group are stiffer and therefore provide more torque than the hairsprings of the first group, at least on average (if not in absolute terms in the case where there is no overlap between the classes of the two groups), the oscillation amplitude will be greater to the same extent (on average or in absolute terms, where appropriate).

The general design of the movement 1 is calculated so as to obtain a good average amplitude for the hairsprings 13 of the first group (for example 280° in DU position with the mainspring fully wound), by obtaining a first predetermined torque at the escape mobile. This predetermined torque will, of course, be subject to standard manufacturing variations, and can vary depending on the winding state of the mainspring housed in the barrel 3, as will be understood by those skilled in the art.

For the hairsprings 13 of the second group, the torque available at the escape mobile is reduced with respect to a movement 1 adapted for the use of a hairspring 13 of the first group. This reduction in torque with respect to the design for the hairsprings 13 of the first group can be obtained by various means, as will be derived more clearly below, and serves to reduce the oscillation amplitude of the oscillator 9 and to return it to the normal and acceptable range even if the hairsprings are stiffer and provide more torque than usual. Indeed, a reduction in torque at the escape mobile implies a reduction in the force of the impulses provided to the oscillator 9 by means of the escapement, and thus a reduced amplitude.

By these means, and taking account of a conventional classification into 20 classes each of 150 s/d, it is possible to use up to double the number of classes of hairsprings 13, that is to say 40 unique classes each of 150 s/d, by a simple adjustment of the torque available at the escape mobile. Of course, it is possible to provide even more groups of classes, and to further increase the variation in stiffness of the hairsprings 13 that is able to be accommodated, and the invention is therefore not limited to two groups.

A first way of obtaining this variation in torque at the escape mobile 7 is to provide an adjustable constant-force mechanism 29 within the movement 1, as illustrated in FIG. 2. In this arrangement, this adjustable constant-force mechanism 29 is schematically illustrated as being located kinematically in the going train 5 between the barrel 3 and the hour mobile 23, but in the alternative, it is possible for it to be arranged between any two mobiles of the going train 5, or to be integrated into any mobile of the going train or even into the barrel or into the escape mobile.

By adjusting the output torque of the constant-force mechanism 29 depending on the group of classes to which the hairspring 13 incorporated in the movement 1 concerned belongs, the torque available at the escape mobile 7 can be regulated so as to obtain an oscillation amplitude in an acceptable range (for example the abovementioned 280°±12.5° in DU position with the mainspring fully wound).

The details of the adjustable constant-force mechanism 29 are not important for the present invention, non-limiting examples of such mechanisms being disclosed in documents CH716126, EP3182217 and EP2166419. Of course, the use of such a mechanism for the purpose of being able to accommodate greater variation in stiffness of hairsprings 13 during series manufacturing has never, to the knowledge of the applicant, been proposed until now.

Another way of obtaining this reduced torque at the escape mobile 7 is at the barrel 3, for example by providing two types of mainspring, one with higher average power (and therefore average torque) for use in combination with the hairsprings 13 of the first group, the other with lower average power (and therefore average torque) for use in combination with the hairsprings 13 of the second group, in such a way as to obtain substantially the same distribution of amplitudes (in terms of the average amplitude of each group and the total amplitude deviation, such as for example the abovementioned 280°±12.5° in DU position with the mainspring fully wound) for oscillators 9 comprising hairsprings 13 of the two groups of classes.

Perhaps the most advantageous way when manufacturing large series of pieces is to vary the gear efficiency of the going train 5. This can be effected in an effective manner by modifying the profile of the toothing of one of the wheels or of one of the pinions. To this end, it is possible to provide two types of a particular mobile 23, 25, 27, a first type comprising a wheel or a pinion with “normal” toothing, a second type comprising a wheel or a pinion with “modified” toothing, in which the profile of the wheel or of the pinion has been predetermined to create a reduction in the gear efficiency with respect to the “normal” toothing.

Although it is possible to modify the form of the toothing of any toothed member (wheel or pinion) of the going train, experiments have shown that a modification of the third wheel 25a (or more generally the wheel of the second mobile kinematically upstream of the escape mobile) optimizes the influence of the modified toothing in a manageable manner.

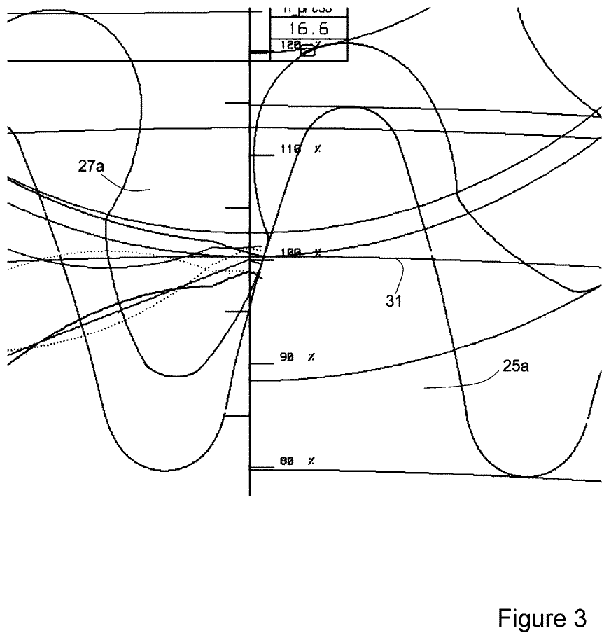

FIG. 3 illustrates the interaction between the “normal” toothing of the third wheel 25a and the seconds pinion 27a, which obtains an average efficiency of 93.93% (calculated) for this gearing, and a total efficiency of 69% for the going train 5.

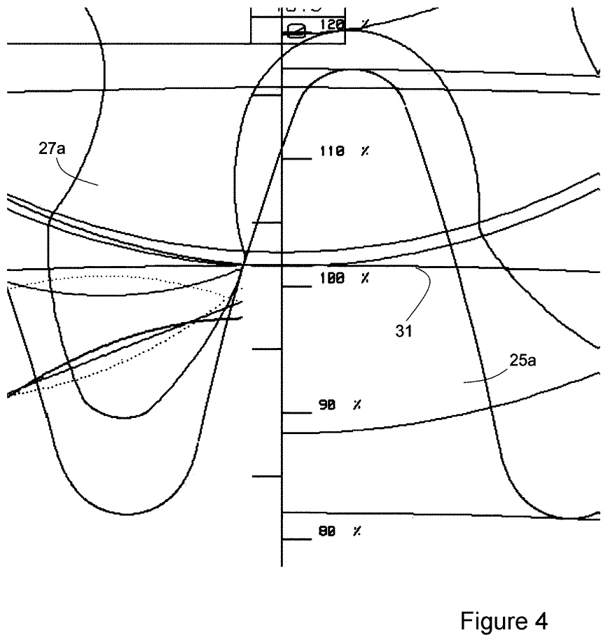

FIG. 4 illustrates the same interaction between the “modified” toothing of the third wheel 25a and the seconds pinion 27a, which obtains an average efficiency of 92.18% (calculated) for this gearing, and a total efficiency of 67% for the going train 5. Experiments have shown that this difference is sufficient to reduce the average amplitude of the oscillators 9 comprising hairsprings 13 of the second group in such a way as to provide substantially the same average amplitude and the same range of amplitude deviation of 20° to 25° (in total) as for the oscillators 9 comprising hairsprings 13 of the first group of 20 classes each with 150 s/d, without overlap between the groups. Consequently, the entire production series of hairsprings 13 of 40 classes each of 150 s/d can fall within the same distribution of amplitudes of oscillators 9 of, for example, 280°±12.5° in DU position with the mainspring fully wound.

Although it is possible to completely redesign the form of the toothing of the modified toothed member, in the example given in FIGS. 3 and 4, the only difference, during manufacture, is a cutter offset for the third wheel 25a, which serves to bring the path of contact toward the axis of the seconds pinion 27a (as demonstrated by the scale in these figures), by adjusting the tool to make a slightly shallower cut, of the order of 30 μm for the wheel 25a illustrated, in order to increase its diameter. In terms of production, this minimal difference and the use of the same tools for the two types of mobiles is extremely efficient and economical to implement.

Consequently, in the present example two types of third mobile 25, more generally of the mobile 23, 25, 27 which is modified for oscillators comprising hairsprings of the second group, are manufactured, and during the assembly of the movement 1, a first “normal” type of this mobile 23, 25, 27 is used in combination with oscillators comprising hairsprings of the first group, and a second “modified” type is used in combination with oscillators comprising hairsprings of the second group. In the case of more than two groups of classes, the number of types of mobiles 23, 25, 27 is adapted accordingly.

During the assembly of the movements, since the only difference is in the choice from among two mobiles depending on the group of classes to which the hairspring 13 of the oscillator 9 belongs, this solution is very economical, does not entail additional components (such as a constant-force mechanism) and is easier to manage than when providing two different mainsprings.

Although the invention has been described in connection with particular embodiments, variations are possible without departing from the scope defined by the attached claims.

1. Method for manufacturing a series of timepiece movements comprising steps of:
manufacturing a plurality of hairsprings;
measuring the stiffness of each of said hairsprings and sorting them according to a plurality of stiffness classes;
manufacturing a plurality of balances according to a determined distribution of moments of inertia depending on said stiffness classes of said hairsprings;
measuring the moment of inertia of each of said balances and sorting them according to a plurality of classes by moment of inertia;
defining a first group of classes of hairsprings and a second group of classes of hairsprings, of which the classes of each individual group are sequential, the average stiffness of the hairsprings of the second group of classes of hairsprings being greater than the average stiffness of the hairsprings of the first group of classes of hairsprings;
pairing each class of hairsprings with a corresponding class of balances;
assembling a plurality of balance-hairspring oscillators each comprising a hairspring and a balance which are paired by classes;
assembling a series of timepiece movements each comprising one of said balance-hairspring oscillators arranged to be sustained by an escapement comprising an escape wheel driven by a going train, in which, for the oscillators comprising a hairspring of the second group of classes, said corresponding movements are arranged in such a way that the torque available at said escape mobile is lower than the torque available at the escape mobile for movements incorporating oscillators comprising a hairspring of the first group of classes.

2. Method as claimed in claim 1, in which said torque available at said escape mobile is determined by adjusting the output torque of a constant-force mechanism comprised by said movements.

3. Method as claimed in claim 1, in which said torque available at the escape mobile is determined at the barrel.

4. Method as claimed in claim 3, in which said torque available at the escape mobile is determined by providing mainsprings having at least two different powers, a more powerful mainspring being selected for the movements containing hairsprings of the first group of classes and a less powerful mainspring being selected for the movements containing hairsprings of the second group of classes.

5. Method as claimed in claim 1, in which said torque available at the escape mobile is determined in terms of the form of the toothing of a predetermined mobile of the going train.

6. Method as claimed in claim 5, in which said torque available at the escape mobile is determined by providing two types of said predetermined mobile having two toothing forms arranged so as to have two different gear efficiencies, one of said predetermined mobiles with greater gear efficiency being selected for movements containing hairsprings of the first group of classes and one of said predetermined mobiles with lower efficiency being selected for the movements containing hairsprings of the second group of classes.

7. Method as claimed in claim 6, in which said two toothing forms are cut by means of the same form of cutter, said cutter being adjusted to cut a toothing with a greater radius in order to obtain mobiles having said lower efficiency, and to cut a toothing with a smaller radius in order to obtain mobiles having said greater efficiency.

8. Method as claimed in claim 5, in which said predetermined mobile of the going train is the third mobile.

9. Method as claimed in claim 8, in which said two different toothings are provided for the third wheel comprised by said third mobile

10. Method as claimed in claim 1, in which all of the set of classes of the first group of classes are different from all of the set of classes of the second group of classes.

11. Method as claimed in claim 1, in which some of the classes of the first group of classes correspond to some of the classes of the second group of classes.

12. A series of timepiece movements manufactured as claimed in claim 1.

13. Timepiece comprising a timepiece movement belonging to the series of movements of claim 12.
